(19) United States
(12) Patent Application Publication
(10) Pub. No.: US 2026/0113544 A1
(43) Pub. Date: Apr. 23, 2026

(54) IMAGE SIGNAL PROCESSOR, IMAGE SYSTEM INCLUDING IMAGE SIGNAL PROCESSOR, AND OPERATION METHOD OF IMAGE SIGNAL PROCESSOR

(71) Applicant: Samsung Electronics Co., Ltd., Suwon-si (KR)

(72) Inventors: Chanyoung Jang, Suwon-si (KR); Dongki Min, Suwon-si (KR); Yonghee Yun, Suwon-si (KR)

(21) Appl. No.: 19/276,865

(22) Filed: Jul. 22, 2025

(30) Foreign Application Priority Data
Oct. 18, 2024 (KR) 10-2024-0143306

(51) Int. Cl. H04N 23/84; H04N 23/76; H04N 23/81

(52) U.S. Cl. CPC H04N 23/843; H04N 23/76; H04N 23/81

(57) ABSTRACT

An image signal processor that receives an input image from an image sensor includes a point spread function (PSF) estimation circuit that adjusts sizes of a plurality of reference PSFs corresponding to the image sensor based on pre-processing image data corresponding to the input image and generates a plurality of estimation PSFs indicating an estimation result for a plurality of PSFs corresponding to the input image, and a remosaic circuit that generates the pre-processing image data based on the input image and performs interpolation for the input image based on the plurality of estimation PSFs.

### CROSS-REFERENCE TO RELATED APPLICATIONS

This application claims priority to Korean Patent Application No. 10-2024-0143306 filed in the Korean Intellectual Property Office on Oct. 18, 2024, the disclosure of which is incorporated by reference herein in its entirety.

### BACKGROUND

An image sensor obtains image information about an external object by converting a light reflected from the external object into an electrical signal. An electronic device which includes the image sensor may display an image in a display panel by using the obtained image information.

The image sensor may be mounted in various types of electronic devices. For example, the electronic device which includes the image sensor may be included as a component of various types of electronic devices such as a smartphone, a tablet personal computer (PC), a laptop PC, and a wearable device.

### SUMMARY

In general, the present disclosure is directed toward an image signal processor with improved performance, an image system including the image signal processor, and an operation method of the image signal processor.

According to some implementations, an image signal processor that receives an input image from an image sensor that includes a point spread function (PSF) estimation module that adjusts sizes of a plurality of reference PSFs corresponding to the image sensor based on pre-processing image data corresponding to the input image and generates a plurality of estimation PSFs indicating an estimation result for a plurality of PSFs corresponding to the input image, and a remosaic module that generates the pre-processing image data based on the input image and performs interpolation for the input image based on the plurality of estimation PSFs.

According to some implementations, the present disclosure is directed to a operation method of an image signal processor that includes receiving an input image from an image sensor, generating pre-processing image data based on the input image, generating a plurality of estimation point spread functions (PSFs) by adjusting sizes of a plurality of reference PSFs corresponding to the image sensor based on the pre-processing image data, and generating an interpolation image by performing interpolation for the input image based on the plurality of estimation PSFs, and the plurality of estimation PSFs indicate an estimation result for a plurality of PSFs respectively corresponding to pixels of the input image.

According to some implementations, the present disclosure is directed to a image system that includes a first image sensor that outputs a first input image, a second image sensor that outputs a second input image, and an image signal processor. The image signal processor includes a memory device that stores first reference point spread function (PSF) data associated with first reference PSFs corresponding to the first image sensor and second reference PSF data associated with second reference PSFs corresponding to the second image sensor, a PSF estimation module that adjusts sizes of the first reference PSFs to generate a plurality of first estimation PSFs indicating an estimation result for PSFs corresponding to the first input image and adjusts sizes of the second reference PSFs to generate a plurality of second estimation PSFs indicating an estimation result for PSFs corresponding to the second input image, and a remosaic module that performs interpolation for the first input image based on the plurality of first estimation PSFs and performs interpolation for the second input image based on the plurality of second estimation PSFs.

### BRIEF DESCRIPTION OF THE DRAWINGS

Example implementation will be more clearly understood from the following detailed description, taken in conjunction with the accompanying drawings.

FIG. 1 is a diagram illustrating an example of an image system according to some implementations.

FIG. 2 is a block diagram illustrating an example of an image sensor of FIG. 1 according to some implementations.

FIGS. 3A and 3B are diagrams illustrating an example of a false color phenomenon caused due to a PSF difference for each color channel according to some implementations.

FIG. 4 is a block diagram illustrating an example of an image signal processor of FIG. 1 according to some implementations.

FIG. 5 is a block diagram illustrating an example of a PSF estimation module and a remosaic module of FIG. 4 according to some implementations.

FIG. 6 is a flowchart illustrating an example of an operation of an image signal processor of FIG. 1 according to some implementations.

FIG. 7 is a flowchart illustrating example operations of generating estimation PSF sets of FIG. 6 according to some implementations.

FIG. 8 is a flowchart illustrating example operations of generating a first estimation PSF set of FIG. 7 according to some implementations.

FIG. 9 is a diagram illustrating an example of a reference PSF set and an estimation PSF sets of FIG. 5 according to some implementations.

FIG. 10 is a diagram illustrating an example of an interpolation image generation method of an image signal processor of FIG. 1 according to some implementations.

FIG. 11 is a block diagram illustrating an example of an interpolation image generation unit of FIG. 5 according to some implementations.

FIGS. 12A and 12B are diagrams illustrating an example of an operation of generating color information image data of FIGS. 10, and 12C is a diagram for describing an operation of generating an interpolation image of FIG. 10 according to some implementations.

FIG. 13 is a block diagram illustrating examples of a PSF estimation module and a remosaic module of FIG. 4 according to some implementations.

FIG. 14 is a diagram illustrating an example of an interpolation image generator of FIG. 13 according to some implementations.

FIG. 15 is a diagram illustrating an example of operations of a color information image data generator and an interpolation image generator of FIG. 14 according to some implementations.

FIG. 16 is a block diagram illustrating an example of an image system according to some implementations.

FIG. 17 is a block diagram illustrating an example of an image sensor according to some implementations.

FIG. 18 is a block diagram illustrating an example of an electronic device including a multi-camera module according to some implementations.

FIG. 19 is a block diagram illustrating an example of a camera module of FIG. 18 according to some implementations.

### DETAILED DESCRIPTION

Hereinafter, example implementations will be explained in detail, with reference to the accompanying drawings.

In the present disclosure, function blocks of drawings, which respectively correspond to the terms “block”, “unit”, “logic”, etc., may be implemented in the form of software, hardware, or a combination thereof.

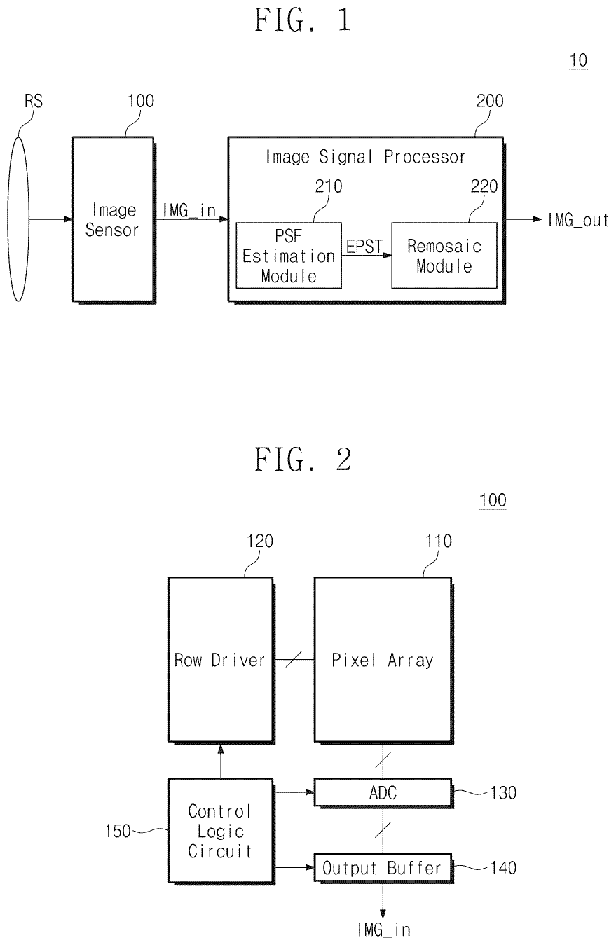

FIG. 1 is a diagram illustrating an example of an image system according to some implementations. In FIG. 1, an image system 10 may include a lens RS, an image sensor 100, and an image signal processor 200. In some implementations, the image system 10 may be realized as a part of various electronic devices, such as a camera, a smartphone, a wearable device, an Internet of Things (IoT) device, home appliances, a tablet personal computer (PC), a personal digital assistant (PDA), a portable multimedia player (PMP), a navigation system, a drone, an advanced drivers assistance system (ADAS), a traffic camera, and a CCTV. Also, the image system 10 may be installed in an electronic device that is provided as a part of a vehicle, furniture, manufacturing equipment, a door, and various kinds of measuring instruments.

The lens RS may correspond to the image sensor 100. The lens RS may receive a light reflected from an external object. The image sensor 100 may generate an electrical image signal, based on the light received through the lens RS. For example, the image sensor 100 may be implemented with a complementary metal oxide semiconductor (CMOS) image sensor or the like. However, the present disclosure is not limited thereto. For example, the image sensor 100 may be implemented based on various image sensors such as a dynamic vision sensor (DVS) and a digital pixel sensor (DPS). The image sensor 100 may output an image generated based on the light reflected from the external object as an input image IMG_in.

The image signal processor 200 may receive the input image IMG_in from the image sensor 100 and may perform image signal processing for the received input image IMG_in. The image signal processor 200 may output an output image IMG_out as a result of the image signal processing. For example, the output image IMG_out may have the quality of image improved compared to the input image IMG_in. The output image IMG_out may be provided to an external device (e.g., an application processor (AP), a graphic processing unit (GPU), or a display device).

The image signal processor 200 may include a point spread function (PSF) estimation module (circuit) 210 and a remosaic module (circuit) 220. The PSF estimation module 210 may estimate PSFs respectively corresponding to pixels of the input image IMG_in. The PSF estimation module 210 may adjust sizes of reference PSFs corresponding to the image sensor 100 to estimate the PSFs corresponding to the input image IMG_in. The PSF estimation module 210 may generate a plurality of estimation PSF sets EPST including the estimated PSFs.

The remosaic module 220 may perform remosaic processing for the input image IMG_in with the non-Bayer pattern (e.g., a tetra pattern or a hexa pattern) to generate a remosaic image of the Bayer format. In some implementations, the remosaic module 220 may perform remosaic processing for the input image IMG_in with the Bayer pattern or the non-Bayer pattern (e.g., a tetra pattern or a hexa pattern) to generate a remosaic image of the RGB format. That is, in this case, the remosaic processing may include all or some of operations which are performed for general demosaic processing. The remosaic module 220 may perform interpolation for the input image IMG_in based on the estimation PSF sets EPST to generate an interpolation image and may generate the remosaic image based on the interpolation image.

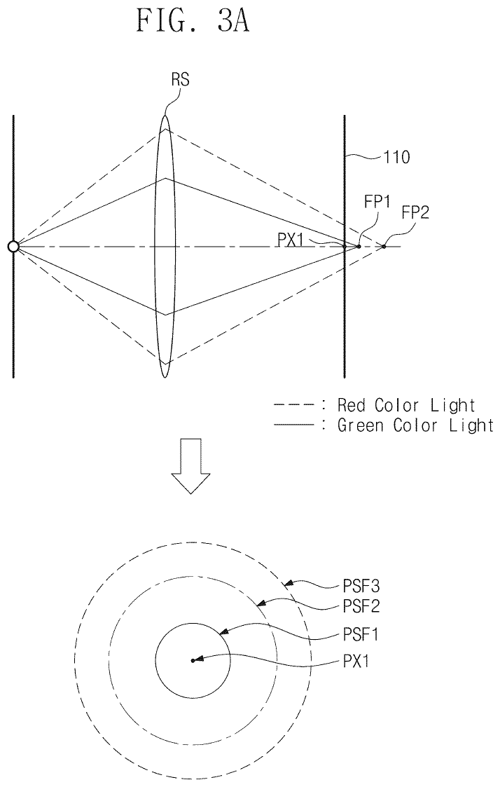

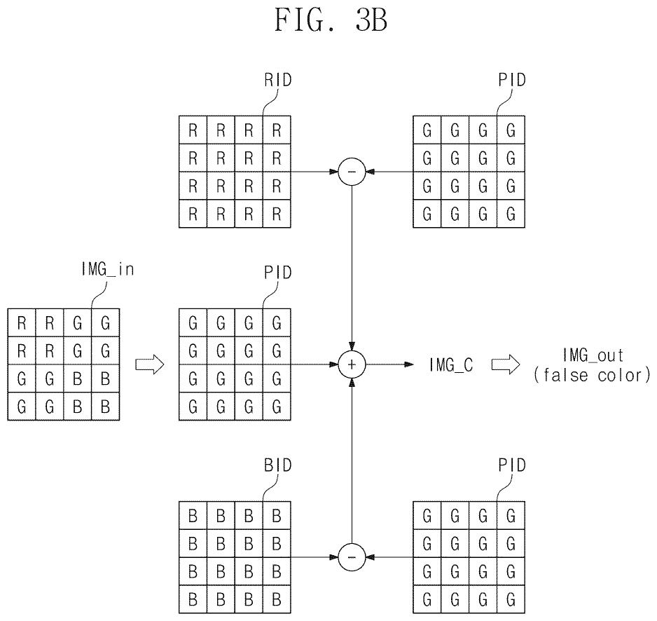

For example, a position where a focus of a red color light corresponding to a first pixel may be different from a focus position of a green color light. Accordingly, the point spread function (PSF) of the red color light may be different from the PSF of the green color light. A false color phenomenon may occur in the output image IMG_out due to a PSF difference for each color (or wavelength) of the light. How the false color phenomenon occurs will be described in detail with reference to FIGS. 3A and 3B.

According to some implementations, as the remosaic module 220 performs interpolation based on the estimation PSF sets EPST, the remosaic module 220 may alleviate the occurrence of the false color phenomenon due to the PSF difference for each color (or wavelength) of the light. Accordingly, the performance of the image system 10 may be improved.

FIG. 2 is a block diagram illustrating an example of an image sensor of FIG. 1 according to some implementations. In FIGS. 1 and 2, the image sensor 100 may include a pixel array 110, a row driver 120, an analog-to-digital converter (ADC) 130, an output buffer 140, and a control logic circuit 150.

The pixel array 110 may include a plurality of pixels. The plurality of pixels may be arranged in a row direction and a column direction. Each of the pixels of the pixel array 110 may output a pixel signal depending on the intensity or the amount of light incident from the outside. In this case, the pixel signal may be an analog signal corresponding to the intensity or the amount of light incident from the outside. In some implementations, the pixel array 110 may include a color filter array (CFA). The color filter array may be implemented to have the Bayer pattern, the tetra pattern, the nona pattern, hexa pattern, a deca pattern, or various color patterns. In some implementations, the input image IMG_in may have the same color pattern as the color filter array of the pixel array 110.

The row driver 120 may provide row control signals (e.g., RST, TX, and SEL) to the pixel array 110. The plurality of pixels of the pixel array 110 may operate in response to the row control signals provided from the row driver 120. The analog-to-digital converter 130 may receive the pixel signals from the plurality of pixels of the pixel array 110 and may convert and output the received pixel signals into digital signals. The output buffer 140 may store the digital signals output from the analog-to-digital converter 130 and may output the stored digital signals as the input image IMG_in. The input image IMG_in may be provided to the image signal processor 200. The control logic circuit 150 may control all the operations of the image sensor 100.

The schematic configuration of the image sensor 100 is described with reference to FIG. 2, and the present disclosure is not limited thereto. It may be understood that the image sensor 100 is able to be implemented in various structures capable of being comprehended by one skilled in the art.

FIGS. 3A and 3B are diagrams illustrating an example of a false color phenomenon caused due to a PSF difference for each color channel according to some implementations. In FIG. 3A, a focal point of the green color light passing through the lens RS after reflected from the external object may be formed at a first focus position FP1. Also, a focal point of the red color light passing through the lens RS after reflected from the external object may be formed at a second focus position FP2. That is, a position of a first pixel PX1 corresponding to the red color light and the green color light may be different from the positions FP1 and FP2 at which the focal points of the red color light and the green color light are formed. Accordingly, the red color light and the green color light passing through the lens RS after reflected from the external object may be spread in the form of the corresponding PSF and may be incident onto the pixel array 110. Meanwhile, because an angle at which the light is incident onto the pixel array 110 varies depending on a focus position, the size of the PSF corresponding to the red color light and the size of the PSF corresponding to the green color light may be different from each other.

For example, the PSF of the green color light corresponding to the first pixel PX1 may be a first PSF (PSF1), the PSF of the red color light corresponding to the first pixel PX1 may be a second PSF (PSF2), and the PSF of the blue color light corresponding to the first pixel PX1 may be a third PSF (PSF3). The size of the PSF may indicate the influence which the light incident onto one pixel has on the pixel values of surrounding pixels. That is, the size of the PSF may indicate the degree of blur of an image. Accordingly, in FIG. 3A, the influence that the red color light incident onto the first pixel PX1 has on pixel values of other pixels may be greater than the influence which the green color light has on the pixel values of the other pixels, and the influence by the blue color light may also be greater than the influence by the green color light.

In FIG. 3B, the image signal processor 200 may obtain red image data RID, panchromatic image data PID, and blue image data BID in the process of interpolating the input image IMG_in. For example, the input image IMG_in may be an image with the tetra pattern. The red image data RID may be generated through interpolation based on red pixel values (R) of the input image IMG_in. The panchromatic image data PID may be generated through interpolation based on green pixel values (G) of the input image IMG_in. The blue image data BID may be generated through interpolation based on blue pixel values (B) of the input image IMG_in.

The red image data RID, the panchromatic image data PID, and the blue image data BID may include pixels, the number of which is equal to that of the input image IMG_in. That is, the pixels of each of the red image data RID, the panchromatic image data PID, and the blue image data BID may respectively correspond to the pixels of the input image IMG_in.

Meanwhile, the panchromatic image data PID may include information about the brightness of the input image IMG_in. The red image data RID and the blue image data BID may include information about colors of the input image IMG_in.

For example, the image signal processor 200 may obtain image data including red color information by subtracting the panchromatic image data PID from the red image data RID. The image signal processor 200 may obtain image data including blue color information by subtracting the panchromatic image data PID from the blue image data BID. The image signal processor 200 may generate interpolation image IMG_C by combining the panchromatic image data PID, the image data including the red color information, and the image data including the blue color information.

In this case, as described above, because the size of the PSF for each color of the light changes, for example, the size of the PSF corresponding to the red image data RID may be larger than the size of the PSF corresponding to the panchromatic image data PID. Also, the size of the PSF corresponding to the blue image data BID may be larger than the size of the PSF corresponding to the panchromatic image data PID. That is, the red image data RID and the blue image data BID may be greater than the panchromatic image data PID in the degree of blur.

As described above, the image signal processor 200 may obtain the image data including the red color information and the image data including the blue color information without consideration of the PSF differences of the red image data RID, the panchromatic image data PID, and the blue image data BID. The image signal processor 200 may generate the interpolation image IMG_C based on the image data including the obtained color information and the panchromatic image data PID. The image signal processor 200 may post-process the interpolation image IMG_C to generate the output image IMG_out. In this case, the false color phenomenon may occur in the output image IMG_out due to the PSF difference of the red image data RID and the panchromatic image data PID and the PSF difference of the blue image data BID and the panchromatic image data PID.

Meanwhile, the PSF may also be determined based on a characteristic of the lens RS. The characteristic of the lens RS may include a defocus degree of the lens RS, a material of the lens RS, a tilt degree of the lens RS, a shape of the lens RS, etc. For example, the defocus degree of the lens RS may be determined based on a distance from the lens RS to the pixel array 110.

Meanwhile, an example in which each of the input image IMG_in, the red image data RID, the panchromatic image data PID, and the blue image data BID includes 16 pixels is illustrated in FIG. 3B, but the present disclosure is not limited thereto.

According to some implementations, the image signal processor 200 may estimate PSFs respectively corresponding to the pixels of the input image IMG_in, based on a current characteristic of the lens RS. In detail, the image signal processor 200 may estimate PSFs respectively corresponding to the pixels of the red image data RID and the blue image data BID. The image signal processor 200 may perform interpolation for the input image IMG_in based on estimation PSF sets including the estimated PSFs. According to the above description, the image signal processor 200 may reduce the PSF difference of the red image data RID and the panchromatic image data PID and the PSF difference of the blue image data BID and the panchromatic image data PID. Accordingly, the image signal processor 200 may alleviate the occurrence of the false color phenomenon due to the PSF difference. An operation of the image system 10 according to an embodiment of the present disclosure will be described in detail with reference to the following drawings.

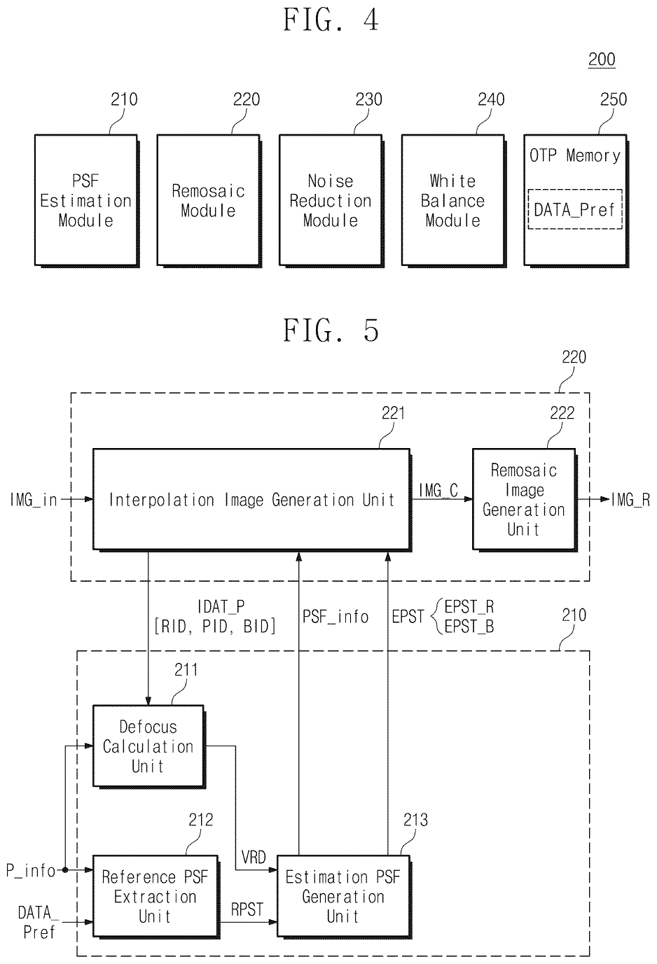

FIG. 4 is a block diagram illustrating an example of an image signal processor of FIG. 1 according to some implementations. In FIG. 4, the image signal processor 200 may include the PSF estimation module 210, the remosaic module 220, a noise reduction module 230, a white balance module 240, and a one time programmable (OTP) memory 250. However, the present disclosure is not limited thereto. For example, the image signal processor 200 may further include an arbitrary type of signal processing circuit or may not include some of the signal processing modules unlike the example illustrated in FIG. 4.

The PSF estimation module 210 may estimate the PSFs respectively corresponding to the pixels of the input image IMG_in. The PSF estimation module 210 may generate the plurality of estimation PSF sets EPST including the estimated PSFs.

The remosaic module 220 may perform remosaic processing for the input image IMG_in. The remosaic module 220 may perform interpolation for the input image IMG_in based on the estimation PSF sets EPST and may generate an interpolation image. The remosaic module 220 may generate the remosaic image based on the interpolation image.

The noise reduction module 230 may be configured to remove the noise of the input image IMG_in. For example, the noise reduction module 230 may be configured to remove a fixed-pattern noise or a temporal random noise according to the color filter array (CFA) of the image sensor 100. The white balance module 240 may perform white balancing. For example, the white balance module 240 may perform white balancing for an output of the noise reduction module 230.

The OTP memory 250 may be configured to store reference PSF data DATA_Pref used to generate the estimation PSF sets EPST. In some implementations, the reference PSF data DATA_Pref may refer to data in which information about reference PSFs respectively corresponding to the pixels of the input image IMG_in is compressed (or encoded). For example, the reference PSFs may be PSFs determined in advance based on the physical characteristic of the lens RS corresponding to the image system 10 in the process of manufacturing the image system 10.

In some implementations, the OTP memory 250 may be a memory incapable of additionally recording data after data are once recorded. Also, the data stored in the OTP memory 250 may not be lost even though the power supplied to the OTP memory 250 is turned off. An example in which the reference PSF data DATA_Pref are stored in the OTP memory 250 is illustrated in FIG. 4, but the present disclosure is not limited thereto. That is, in some implementations, the reference PSF data DATA_Pref may be stored in any other nonvolatile memory other than an OTP memory.

FIG. 5 is a block diagram illustrating examples of a PSF estimation module and a remosaic module of FIG. 4 according to some implementations. In FIGS. 1, 4, and 5, the PSF estimation module (circuit) 210 may include a defocus calculation unit (circuit) 211, a reference PSF extraction unit (circuit) 212, and an estimation PSF generation unit (circuit) 213. The remosaic module 220 may include an interpolation image generation unit (circuit) 221 and a remosaic image generation unit (circuit) 222.

The defocus calculation unit 211 may receive pre-processing image data IDAT_P generated based on the input image IMG_in, from the interpolation image generation unit 221. The pre-processing image data IDAT_P may include the red image data RID, the panchromatic image data PID, and the blue image data BID. The red image data RID, the panchromatic image data PID, and the blue image data BID may respectively correspond to the red image data RID, the panchromatic image data PID, and the blue image data BID of FIG. 3B.

The defocus calculation unit 211 may receive position information P_info indicating information about a position of each pixel of the input image IMG_in. In some implementations, the defocus calculation unit 211 may receive the position information P_info from a control circuit controlling the image signal processor 200. In an embodiment, the defocus calculation unit 211 may receive the position information P_info from the control logic circuit 150 of FIG. 2.

The defocus calculation unit 211 may calculate variance ratios respectively corresponding to the pixels of the input image IMG_in based on the position information P_info and the pre-processing image data IDAT_P. The defocus calculation unit 211 may transmit variance ratio data VRD including the calculated variance ratios to the estimation PSF generation unit 213. In some implementations, the calculated variance ratios may include first variance ratios and second variance ratios. The first variance ratios may include information about the PSF difference of the red image data RID and the panchromatic image data PID. The second variance ratios may include information about the PSF difference of the blue image data BID and the panchromatic image data PID.

The reference PSF extraction unit 212 may receive the position information P_info and the reference PSF data DATA_Pref. In some implementations, the reference PSF extraction unit 212 may receive the reference PSF data DATA_Pref from the OTP memory 250. In some implementations, the reference PSF extraction unit 212 may receive the position information P_info from the control circuit (not illustrated) controlling the image signal processor 200. In some implementations, the reference PSF extraction unit 212 may receive the position information P_info from the control logic circuit 150 of FIG. 2.

The reference PSF extraction unit 212 may obtain a reference PSF set RPST including reference PSFs respectively corresponding to the pixels of the input image IMG_in based on the reference PSF data DATA_Pref. In detail, the reference PSF extraction unit 212 may perform decompression (or decoding) for the reference PSF data DATA_Pref to extract the reference PSF set RPST. The reference PSF extraction unit 212 may transmit the reference PSF set RPST to the estimation PSF generation unit 213.

The estimation PSF generation unit 213 may generate a plurality of estimation PSF sets EPST based on the variance ratio data VRD and the reference PSF set RPST. The plurality of estimation PSF sets EPST may include a first estimation PSF set EPST_R and a second estimation PSF set EPST_B. The first estimation PSF set EPST_R may include a plurality of first estimation PSFs respectively corresponding to the pixels of the input image IMG_in, and the second estimation PSF set EPST_B may include a plurality of second estimation PSFs respectively corresponding to the pixels of the input image IMG_in.

The estimation PSF generation unit 213 may adjust the size of each of the reference PSFs of the reference PSF set RPST based on the first variance ratios and may generate the first estimation PSFs. The estimation PSF generation unit 213 may adjust the size of each of the reference PSFs of the reference PSF set RPST based on the second variance ratios and may generate the second estimation PSFs. The estimation PSF generation unit 213 may transmit the estimation PSF sets EPST and PSF information PSF_info to the interpolation image generation unit 221. In an embodiment, the PSF information PSF_info may include information about image data to which the estimation PSF sets EPST will be applied.

As described above, the estimation PSF sets EPST may be generated based on the variance ratio data VRD corresponding to the input image IMG_in. Accordingly, the estimation PSF sets EPST may include PSFs estimated based on a current characteristic (e.g., a defocus degree or a tilt degree) of the lens RS corresponding to the image sensor 100.

The interpolation image generation unit 221 may interpolate the input image IMG_in to generate the pre-processing image data IDAT_P including the red image data RID, the panchromatic image data PID, and the blue image data BID. The interpolation image generation unit 221 may perform interpolation for the input image IMG_in based on the estimation PSF sets EPST and may generate the interpolation image IMG_C.

For example, the interpolation image generation unit 221 may apply the estimation PSF sets EPST to at least some of the red image data RID, the panchromatic image data PID, and the blue image data BID. In this case, the PSF sizes of the at least some of the red image data RID, the panchromatic image data PID, and the blue image data BID may be adjusted. The interpolation image generation unit 221 may generate the interpolation image IMG_C by utilizing image data whose PSF is adjusted. According to the above description, the interpolation image IMG_C may be an image in which the occurrence of the false color phenomenon due to the PSF differences of the red image data RID, the panchromatic image data PID, and the blue image data BID is alleviated. In an embodiment, the interpolation image IMG_C may be an image of the RGB format, which includes all of the red pixel value (R), the green pixel value (G), and the blue pixel value (B).

The remosaic image generation unit 222 may perform post-processing for the interpolation image IMG_C to generate a remosaic image IMG_R. In some implementations, the remosaic image IMG_R may be an image of the RGB format. In some implementations, the remosaic image IMG_R may be an image of the Bayer format. In this case, the remosaic image generation unit 222 may adjust the arrangement of the interpolation image IMG_C to generate the remosaic image IMG_R of the Bayer format.

As described above, according to some implementations, the image signal processor 200 may estimate the PSFs corresponding to the input image IMG_in. The image signal processor 200 may adjust the sizes of the PSFs corresponding to the input image IMG_in based on the estimated PSFs and may then perform interpolation for the input image IMG_in. According to the above description, the image signal processor 200 may alleviate the occurrence of the false color phenomenon due to the PSF difference for each color channel.

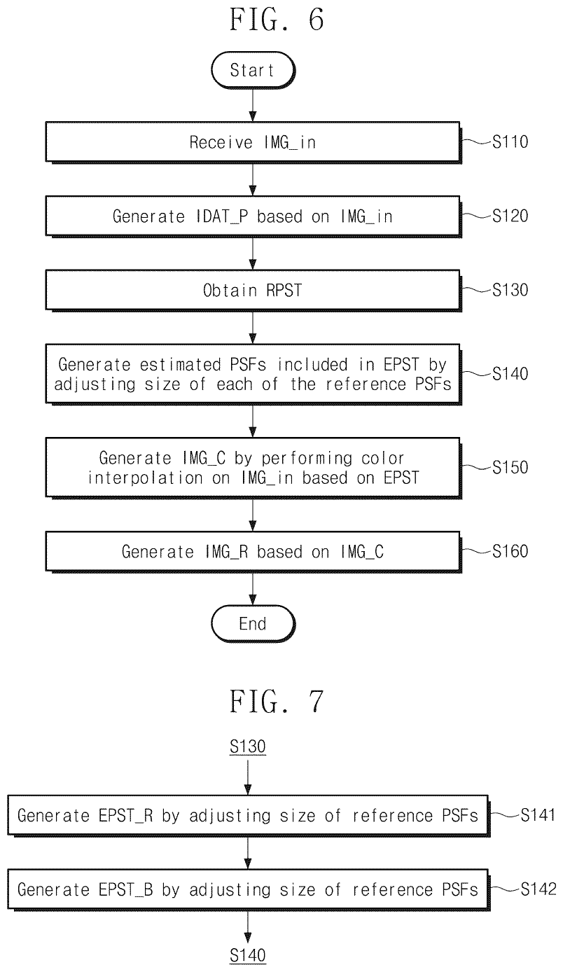

FIG. 6 is a flowchart illustrating an example of an operation of an image signal processor of FIG. 1 according to some implementations. In FIGS. 1, 5, and 6, in operation S110, the image signal processor 200 may receive the input image IMG_in.

In operation S120, the image signal processor 200 may generate the pre-processing image data IDAT_P based on an input image. For example, the remosaic module 220 may interpolate the input image IMG_in to generate the pre-processing image data IDAT_P including the red image data RID, the panchromatic image data PID, and the blue image data BID.

In operation S130, the image signal processor 200 may obtain the reference PSF set RPST. For example, the PSF estimation module 210 may obtain the reference PSF set RPST including the reference PSFs respectively corresponding to the pixels of the input image IMG_in based on the reference PSF data DATA_Pref.

In operation S140, the image signal processor 200 may adjust the sizes of the reference PSFs to generate the estimation PSFs to be included in the estimation PSF sets EPST. For example, the PSF estimation module 210 may generate the variance ratio data VRD based on the pre-processing image data IDAT_P. The PSF estimation module 210 may generate the estimation PSF sets EPST by adjusting the sizes of the reference PSFs based on the variance ratio data VRD.

In operation S150, the image signal processor 200 may perform interpolation for the input image based on the estimation PSF sets EPST and may generate the interpolation image IMG_C. For example, the remosaic module 220 may generate the interpolation image IMG_C by applying the estimation PSF sets EPST to the pre-processing image data IDAT_P.

In operation S160, the image signal processor 200 may generate remosaic image IMG_R based on the interpolation image IMG_C. For example, the remosaic module 220 may perform post-processing for the interpolation image IMG_C to generate the remosaic image IMG_R of the RGB format or the Bayer format.

FIG. 7 is a flowchart illustrating example operations of generating estimation PSF sets of FIG. 6 according to some implementations. In FIGS. 1 and 5 to 7, in operation S141, the image signal processor 200 may adjust the size of the reference PSFs to generate the first estimation PSF set EPST_R. For example, the PSF estimation module 210 may generate the first estimation PSF set EPST_R by adjusting the sizes of the reference PSFs of the reference PSF set RPST based on the pre-processing image data IDAT_P.

For example, the size of the PSF corresponding to each of the pixels of the red image data RID may be larger than the size of the PSF corresponding to each of the pixels of the panchromatic image data PID. The first estimation PSF set EPST_R may include first PSFs each indicating an estimation result for the PSF of each pixel of the red image data RID. That is, the first PSFs may be PSFs corresponding to the red color channel of the input image IMG_in.

In operation S142, the image signal processor 200 may adjust the sizes of the reference PSFs to generate the second estimation PSF set EPST_B. For example, the PSF estimation module 210 may generate the second estimation PSF set EPST_B by adjusting the sizes of the reference PSFs of the reference PSF set RPST based on the pre-processing image data IDAT_P.

For example, the size of the PSF corresponding to each of the pixels of the blue image data BID may be larger than the size of the PSF corresponding to each of the pixels of the panchromatic image data PID. The second estimation PSF set EPST_B may include first PSFs each indicating an estimation result for the PSF of each pixel of the blue image data BID. That is, the second PSFs may be PSFs corresponding to the blue color channel of the input image IMG_in.

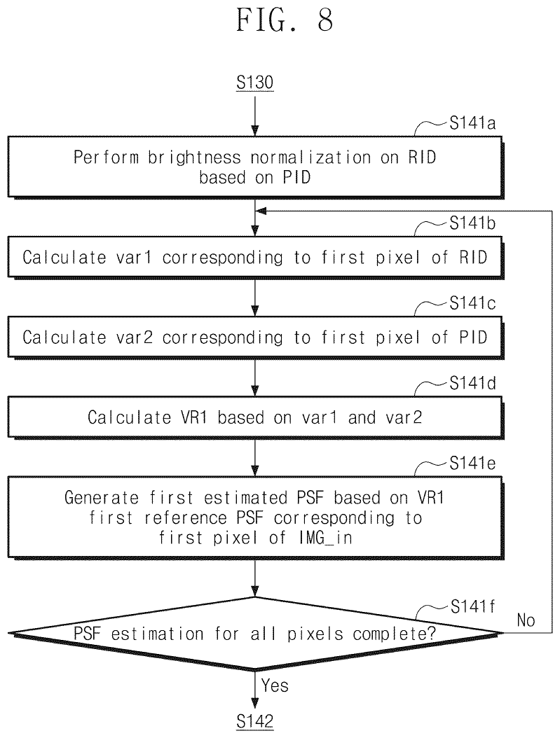

FIG. 8 is a flowchart illustrating example operations of generating a first estimation PSF set of FIG. 7 according to some implementations. In FIGS. 1 and 5 to 8, in operation S141a, the image signal processor 200 may perform brightness normalization for the red image data RID based on the panchromatic image data PID. For example, the defocus calculation unit 211 may generate red normalization image data NRID by performing brightness normalization for the red image data RID based on Equation 1 below.

$$N R I D ( x , y ) = \frac{mean ( P I D )}{mean ( R I D )} R I D ( x , y ) \qquad [ Equation 1 ]$$

In Equation 1, [symbol] per pixel positioned at (x, y) in the red normalization image data NRID, mean (PID) is a mean of pixel values of the panchromatic image data PID, mean (RID) is a mean of pixel values of the red image data RID, and RID (x, y) is a pixel value of a pixel positioned at (x, y) in the red image data RID. The red normalization image data NRID may indicate a result obtained by adjusting the brightness of the red image data RID based on the brightness of the panchromatic image data PID.

In operation S141b, the image signal processor 200 may calculate a first variance var1 corresponding to a first pixel of the red image data RID. For example, the defocus calculation unit 211 may calculate the first variance var1 based on a pixel value of the first pixel of the red image data RID and pixel values of “n” pixels around the first pixel. The first variance var1 may include information about the size of the PSF corresponding to the first pixel of the red image data RID. For example, as the first variance var1 increases, the size of the PSF corresponding to the first pixel of the red image data RID may decrease.

In operation S141c, the image signal processor 200 may calculate a second variance var2 corresponding to a first pixel of the panchromatic image data PID. In an embodiment, the first pixel of the panchromatic image data PID may mean a pixel, whose position corresponds to the position of the first pixel of the red image data RID, from among the pixels of the panchromatic image data PID. For example, the defocus calculation unit 211 may calculate the second variance var2 based on a pixel value of the first pixel of the panchromatic image data PID and pixel values of “n” pixels around the first pixel. The second variance var2 may include information about the size of the PSF corresponding to the first pixel of the panchromatic image data PID. For example, as the second variance var2 increases, the size of the PSF corresponding to the first pixel of the panchromatic image data PID may decrease.

In operation S141d, the image signal processor 200 may calculate a first variance ratio based on the first variance var1 and the second variance var2. For example, the defocus calculation unit 211 may calculate a first variance ratio VR1 based on Equation 2 below.

$$V R 1 = \{ \begin{matrix}var 1 / var 2 , & var 1 < var 2 \\ var 2 / var 1 , & var 1 \geq var 2\end{matrix} \qquad [ Equation 2 ]$$

The reference signs in Equation 2 are described above, and additional description will be omitted to avoid redundancy. For example, the first variance ratio VR1 may include information about a size difference of the PSF of the first pixel of the red image data RID and the PSF of the first pixel of the panchromatic image data PID. For example, the first variance var1 may be smaller than the second variance var2. In this case, the first variance ratio VR1 may indicate how much the size of the PSF of the first pixel of the red image data RID is larger than the size the PSF of the first pixel of the panchromatic image data PID. For example, the second variance var2 may be smaller than the first variance var1. In this case, the first variance ratio VR1 may indicate how much the size of the PSF of the first pixel of the red image data RID is smaller than the size the PSF of the first pixel of the panchromatic image data PID.

In operation S141e, the image signal processor 200 may generate the first estimation PSF based on the first variance ratio VR1 and the first reference PSF corresponding to the first pixel of the input image IMG_in. For example, the estimation PSF generation unit 213 may obtain the first variance ratio VR1 from the variance ratio data VRD received from the defocus calculation unit 211. Also, the estimation PSF generation unit 213 may obtain the first reference PSF from the reference PSF set RPST. For example, the estimation PSF generation unit 213 may calculate a variance of the first reference PSF.

The estimation PSF generation unit 213 may adjust the size of the first reference PSF based on the first variance ratio VR1 and the variance of the first reference PSF and may generate the first estimation PSF. The first pixel of the input image IMG_in may correspond to the first pixel of the red image data RID and the first pixel of the panchromatic image data PID. For example, the estimation PSF generation unit 213 may determine the following based on the first variance ratio VR1 and the variance of the first reference PSF: how much the size of the first reference PSF increases, how much the size of the first reference PSF decreases, or whether the size of the first reference PSF is maintained. For example, the estimation PSF generation unit 213 may check the size of the first reference PSF based on the variance of the first reference PSF. The estimation PSF generation unit 213 may determine whether to increase, decrease, or maintain the size of the first reference PSF, based on the first variance ratio VR1.

The estimation PSF generation unit 213 may determine the degree of increase or decrease of the size of the first reference PSF based on the first variance ratio VR1. That a value of the first variance ratio VR1 becomes closer to “0” may mean that the PSF difference of the red image data RID and the panchromatic image data PID corresponding to the first pixel becomes greater. Accordingly, the estimation PSF generation unit 213 may determine that the degree of increase or decrease becomes greater as a value of the first variance ratio VR1 becomes closer to “0”. The estimation PSF generation unit 213 may adjust the size of the first reference PSF based on the determined increase or decrease degree and may generate the first estimation PSF.

For example, when a first variance is smaller than a second variance, the size of the first estimation PSF may correspond to the size of the PSF of the first pixel of the red image data RID. For example, when the first variance is greater than the second variance, the size of the first estimation PSF may correspond to the size of the PSF of the first pixel of the panchromatic image data PID.

For example, when the first variance is smaller than the second variance, the estimation PSF generation unit 213 may generate the PSF information PSF_info including information indicating that the first estimation PSF may correspond to the size of the PSF of the first pixel of the red image data RID.

In operation S141f, the image signal processor 200 may determine whether PSF estimation is completed in association with all the pixels of the red image data RID and the panchromatic image data PID. For example, when the estimation is not completed, the image signal processor 200 may perform operation S141b. When the estimation is completed, the first estimation PSFs corresponding to all the pixels of the red image data RID and the panchromatic image data PID may be generated. When the estimation is completed, the image signal processor 200 may perform operation S142.

As already described above, the pixels of each of the red image data RID and the panchromatic image data PID respectively correspond to the pixels of the input image IMG_in. Accordingly, the first estimation PSFs may respectively correspond to the pixels of the input image IMG_in.

In operation S142, the image signal processor 200 may generate the second estimation PSF set EPST_B in a manner similar to the above manner of generating the first estimation PSF set EPST_R. In detail, the image signal processor 200 may perform brightness normalization for the blue image data BID based on the panchromatic image data PID, may calculate a first variance corresponding to the first pixel of the blue image data BID, may calculate a second variance corresponding to the first pixel of the panchromatic image data PID, may calculate a first variance ratio based on the first variance and the second variance, and may generate the second estimation PSF by adjusting the size of the first reference PSF based on the first variance ratio. The image signal processor 200 may generate the second estimation PSF set EPST_B including the second estimation PSFs corresponding to all the pixels of the blue image data BID and the panchromatic image data PID.

As described above, the pixels of each of the blue image data BID and the panchromatic image data PID respectively correspond to the pixels of the input image IMG_in. Accordingly, the second estimation PSFs may respectively correspond to the pixels of the input image IMG_in.

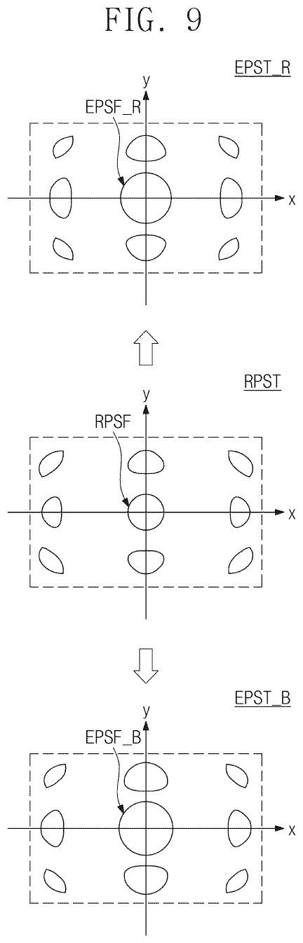

FIG. 9 is a diagram illustrating an example of a reference PSF set and an estimation PSF sets of FIG. 5 according to some implementations. In FIGS. 1 and 5 to 9, the reference PSF set RPST may include a plurality of reference PSFs RPSF. The reference PSF set RPST may include the reference PSFs RPSF respectively corresponding to the pixels of the input image IMG_in. For example, like the example of FIG. 3B, when the input image IMG_in includes 16 pixels, the reference PSF set RPST may include 16 reference PSFs RPSF. The reference PSFs RPSF may respectively correspond to the pixels of the input image IMG_in.

The first estimation PSF set EPST_R may include a plurality of first estimation PSFs EPSF_R. As described with reference to FIG. 9, each of the first estimation PSFs EPSF_R may be generated by adjusting the size of the corresponding reference PSF RPSF based on a variance ratio. In association with the corresponding pixel, each of the first estimation PSFs EPSF_R may be similar in size to a PSF having a larger size from among the PSF of the pixel of the red image data RID and the PSF of the pixel of the panchromatic image data PID. The first estimation PSFs EPSF_R may respectively correspond to the pixels of the input image IMG_in.

The second estimation PSF set EPST_B may include a plurality of second estimation PSFs EPSF_B. As described with reference to FIG. 9, each of the second estimation PSFs EPSF_B may be generated by adjusting the size of the corresponding reference PSF RPSF based on a variance ratio. In association with the corresponding pixel, each of the second estimation PSFs EPSF_B may be similar in size of the PSF having a larger size from among the PSF of the pixel of the blue image data BID and the PSF of the pixel of the panchromatic image data PID. The second estimation PSFs EPSF_B may respectively correspond to the pixels of the input image IMG_in.

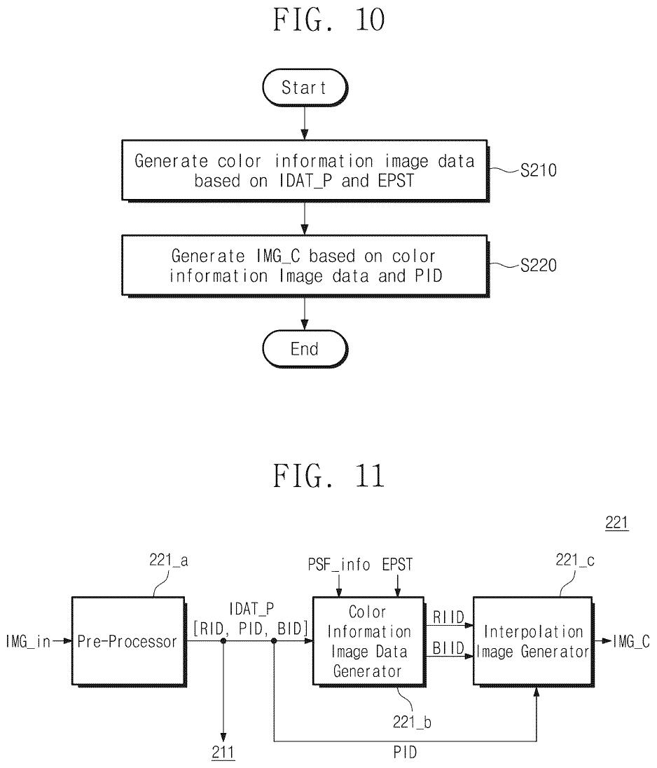

FIG. 10 is a diagram illustration of an example of an interpolation image generation method of an image signal processor of FIG. 1 according to some implementations. In FIGS. 1 and 5 to 10, in operation S210, the image signal processor 200 may generate color information image data based on the pre-processing image data IDAT_P and the estimation PSF sets EPST. For example, the interpolation image generation unit 221 may adjust PSFs of at least some of the red image data RID, the panchromatic image data PID, and the blue image data BID based on the estimation PSF sets EPST. The interpolation image generation unit 221 may generate the color information image data based on the adjusted image data.

In operation S220, the image signal processor 200 may generate the interpolation image IMG_C based on the color information image data and the panchromatic image data PID. For example, the interpolation image generation unit 221 may generate the interpolation image IMG_C by combing the color information image data and the panchromatic image data PID.

FIG. 11 is a block diagram illustrating an example of an interpolation image generation unit of FIG. 5 according to some implementations. In FIGS. 1 and 5 to 11, the interpolation image generation unit 221 may include a pre-processor 221_a, a color information image data generator 221_b, and an interpolation image generator 221_c. The pre-processor 221_a may generate the pre-processing image data IDAT_P including the red image data RID, the panchromatic image data PID, and the blue image data BID based on the input image IMG_in. The pre-processor 221_a may generate the red image data RID, the panchromatic image data PID, and the blue image data BID based on the pixel values of the input image IMG_in. The pre-processor 221_a may transmit the pre-processing image data IDAT_P to the defocus calculation unit 211 and the color information image data generator 221_b.

The color information image data generator 221_b may generate red information image data RIID and blue information image data BIID based on the pre-processing image data IDAT_P, the PSF information PSF_info, and the estimation PSF sets EPST. The color information image data generator 221_b may adjust the size of the PSF corresponding to the red image data RID or the panchromatic image data PID based on the first estimation PSF set EPST_R.

For example, the size of the PSF corresponding to the red image data RID may be larger than the size of the PSF corresponding to the panchromatic image data PID. In this case, the first estimation PSF set EPST_R may include the first estimation PSFs indicating a current PSF of the red image data RID. Also, the PSF information PSF_info may include information indicating that the size of the PSF corresponding to the red image data RID is larger than the size of the PSF corresponding to the panchromatic image data PID. The color information image data generator 221_b may check that the size of the PSF corresponding to the red image data RID is larger than the size of the PSF corresponding to the panchromatic image data PID, based on the PSF information PSF_info.

According to the above description, the color information image data generator 221_b may increase the size of the PSF corresponding to the panchromatic image data PID based on the first estimation PSF set EPST_R. The color information image data generator 221_b may generate the red information image data RIID based on the panchromatic image data PID whose PSF size is adjusted and the red image data RID. The red information image data RIID may include color information about the red color of the input image IMG_in.

The color information image data generator 221_b may adjust the PSF size of the blue image data BID or the panchromatic image data PID based on the second estimation PSF set EPST_B. For example, the size of the PSF corresponding to the blue image data BID may be larger than the size of the PSF corresponding to the panchromatic image data PID. In this case, the PSF information PSF_info may include information indicating that the size of the PSF corresponding to the blue image data BID is larger than the size of the PSF corresponding to the panchromatic image data PID. The color information image data generator 221_b may check that the size of the PSF corresponding to the blue image data BID is larger than the size of the PSF corresponding to the panchromatic image data PID, based on the PSF information PSF_info.

In this case, like the case where the color information image data generator 221_b generates the red information image data RIID, the color information image data generator 221_b may increase the size of the PSF corresponding to the panchromatic image data PID based on the second estimation PSF set EPST_B and may then generate the blue information image data BIID. The blue information image data BIID may include color information about the blue color of the input image IMG_in.

The interpolation image generator 221_c may generate the interpolation image IMG_C by combing the red information image data RIID, the blue information image data BIID, and the panchromatic image data PID.

As described above, the color information image data generator 221_b may adjust the size of the PSF of the image data based on the estimation PSF sets EPST and may then generate the color information image data RIID and BIID. Accordingly, the PSF differences of the red image data RID, the blue image data BID, and the panchromatic image data PID may decrease in the process of generating the color information image data RIID and BIID. Accordingly, the occurrence of the false color phenomenon on the output image IMG_out generated based on the interpolation image IMG_C may be alleviated.

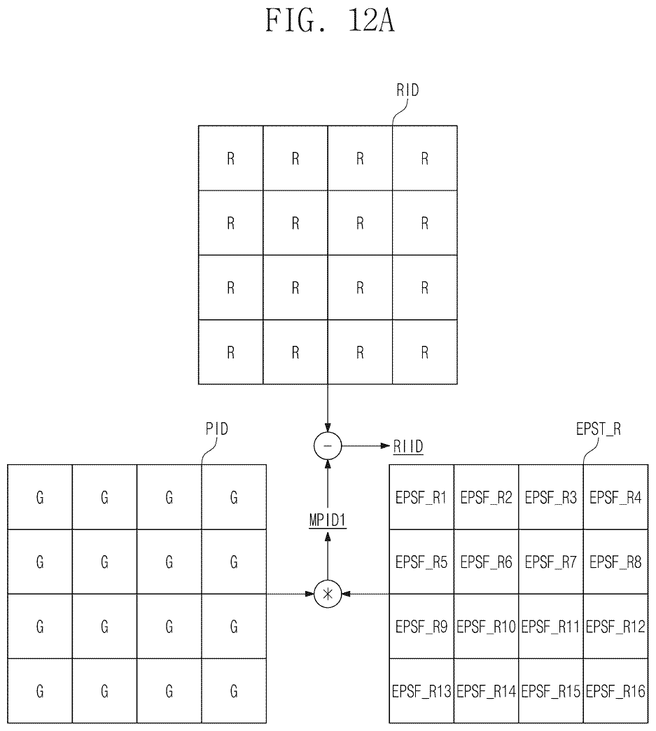

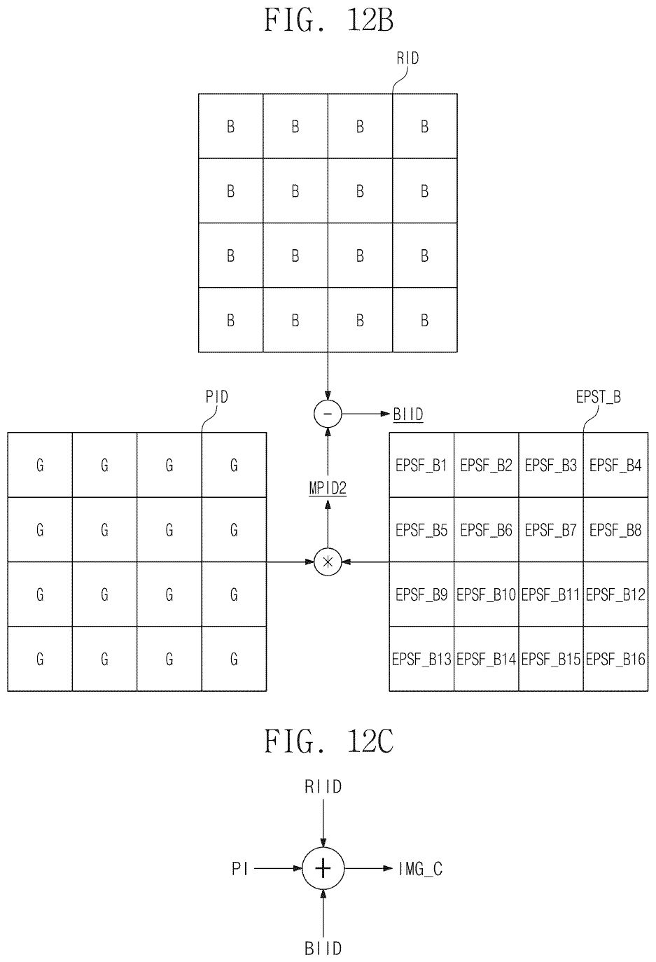

FIGS. 12A and 12B are diagrams illustrating an example of an operation of generating color information image data of FIG. 10 according to some implementations, and 12C is a diagram illustrating an example of an operation of generating an interpolation image of FIG. 10 according to some implementations. In FIGS. 12A to 12C, it is assumed that the sizes of the PSFs corresponding to the red image data RID and the blue image data BID are larger than the size of the PSFs corresponding to the panchromatic image data PID.

In FIG. 12A, the first estimation PSF set EPST_R may include a plurality of first estimation PSFs EPSF_R1 to EPSF_R16. The first estimation PSFs EPSF_R1 to EPSF_R16 may respectively correspond to the PSFs of the pixels of the red image data RID. The color information image data generator 221_b may perform convolution between the panchromatic image data PID and the first estimation PSF set EPST_R and may generate first adjustment panchromatic image data MPID1.

For example, the color information image data generator 221_b may generate the first adjustment panchromatic image data MPID1 by performing convolution between each of the green pixel values (G) of the panchromatic image data PID and the first estimation PSF (e.g., one of EPSF_R1 to EPSF_R16) of the corresponding position.

For example, the color information image data generator 221_b may determine a pixel (in the above example, the pixel of the panchromatic image data PID) having a smaller PSF from among the pixels of the panchromatic image data PID and the red image data RID and may generate the first adjustment panchromatic image data MPID1 by performing convolution between the determined pixel and the first estimation PSF corresponding thereto.

Through the convolution, the size of the PSF of the first adjustment panchromatic image data MPID1 may be similar to the size of the PSF of the red image data RID. That is, the size of the PSF corresponding to the first adjustment panchromatic image data MPID1 may become larger than the size of the PSF corresponding to the panchromatic image data PID. The color information image data generator 221_b may generate the red information image data RIID by subtracting the first adjustment panchromatic image data MPID1 from the red image data RID. The red information image data RIID may be data generated after the PSF difference of the red information image data RIID and the panchromatic image data PID is corrected. Also, the red information image data RIID may be data including red color information of the input image IMG_in.

In FIG. 12B, the second estimation PSF set EPST_B may include a plurality of second estimation PSFs EPSF_B1 to EPSF_B16. The second estimation PSFs EPSF_B1 to EPSF_B16 may respectively correspond to the PSFs of the pixels of the blue image data BID. The color information image data generator 221_b may perform convolution between the panchromatic image data PID and the second estimation PSF set EPST_B and may generate second adjustment panchromatic image data MPID2.

For example, the color information image data generator 221_b may generate the second adjustment panchromatic image data MPID2 by performing convolution between each of the green pixel values (G) of the panchromatic image data PID and the second estimation PSF (e.g., one of EPSF_B1 to EPSF_B16) of the corresponding position.

For example, the color information image data generator 221_b may determine a pixel (in the above example, the pixel of the panchromatic image data PID) having a smaller PSF from among the pixels of the panchromatic image data PID and the blue image data BID and may generate the second adjustment panchromatic image data MPID2 by performing convolution between the determined pixel and the second estimation PSF corresponding thereto.

Through the convolution, the size of the PSF of the second adjustment panchromatic image data MPID2 may be similar to the size of the PSF of the blue image data BID. That is, the size of the PSF corresponding to the second adjustment panchromatic image data MPID2 may become larger than the size of the PSF corresponding to the panchromatic image data PID. The color information image data generator 221_b may generate the blue information image data BIID by subtracting the second adjustment panchromatic image data MPID2 from the blue image data BID. The blue information image data BIID may be data generated after the PSF difference of the blue information image data BIID and the panchromatic image data PID is corrected. Also, the blue information image data BIID may be data including blue color information of the input image IMG_in.

In FIG. 12C, the interpolation image generator 221_c may generate the interpolation image IMG_C by combing the red information image data RIID, the blue information image data BIID, and the panchromatic image data PID. As described above, the interpolation image IMG_C may be generated based on the red information image data RIID in which the PSF difference of the red image data RID and the panchromatic image data PID is corrected and the blue information image data BIID in which the PSF difference of the blue image data BID and the panchromatic image data PID is corrected. Accordingly, the output image IMG_out generated based on the interpolation image IMG_C may be image data in which the false color phenomenon due to the PSF difference is alleviated.

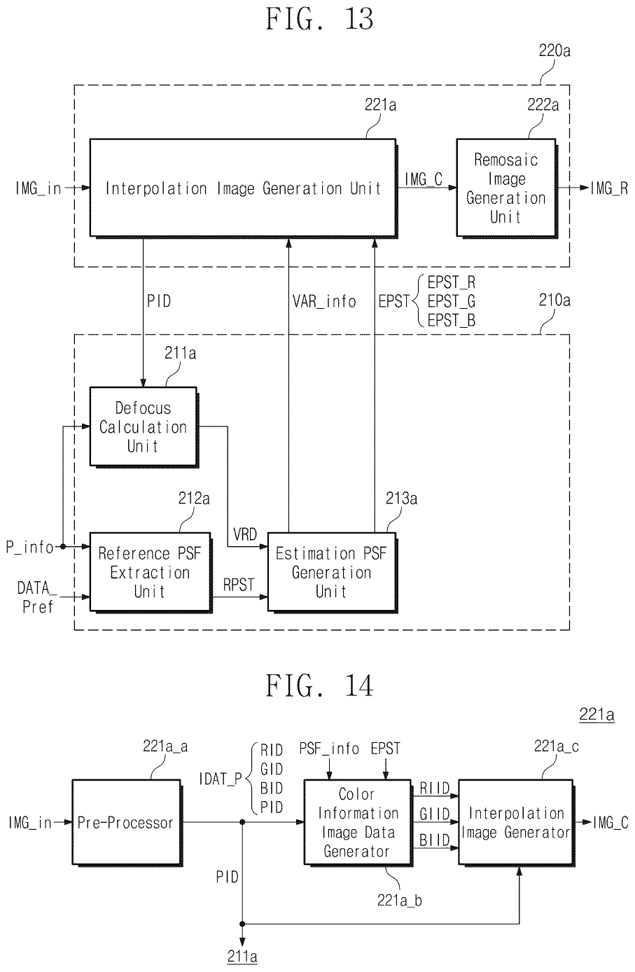

FIG. 13 is a block diagram illustrating examples of a PSF estimation module and a remosaic module of FIG. 4 according to some implementations. In FIG. 13, a PSF estimation module 210a may include a defocus calculation unit 211a, a reference PSF extraction unit 212a, and an estimation PSF generation unit 213a. The defocus calculation unit 211a, the reference PSF extraction unit 212a, and the estimation PSF generation unit 213a may respectively correspond to the defocus calculation unit 211, the reference PSF extraction unit 212, and the estimation PSF generation unit 213 of FIG. 5. A remosaic module 220a may include an interpolation image generation unit 221a and a remosaic image generation unit 222a. The interpolation image generation unit 221a and the remosaic image generation unit 222a may respectively correspond to the interpolation image generation unit 221 and the remosaic image generation unit 222 of FIG. 5.

Because operations of the components included in the PSF estimation module 210a and the remosaic module 220a are described with reference to FIGS. 5 to 12, below, a difference between FIG. 5 and FIG. 13 will be mainly described.

In FIG. 13, the interpolation image generation unit 221a may generate the panchromatic image data PID based on the input image IMG_in. In detail, the interpolation image generation unit 221a may interpolate the input image IMG_in and may generate the panchromatic image data PID in which the pixels have the same red pixel values (R), the same green pixel values (G), and the same blue pixel values (B) and have the saturation of “0”. The panchromatic image data PID may include information about the brightness of the input image IMG_in. Unlike the case of FIG. 5, the interpolation image generation unit 221a may transmit only the panchromatic image data PID to the defocus calculation unit 211a.

The defocus calculation unit 211a may generate the variance ratio data VRD based on the input image IMG_in and the panchromatic image data PID. The variance ratio data VRD may include first variance ratios each indicating the PSF difference of the red image data RID and the panchromatic image data PID for each pixel. The variance ratio data VRD may include second variance ratios each indicating the PSF difference of green image data GID (refer to FIG. 14) and the panchromatic image data PID for each pixel. The variance ratio data VRD may include third variance ratios each indicating the PSF difference of the blue image data BID and the panchromatic image data PID for each pixel.

The defocus calculation unit 211a may calculate first variances each indicating the pixel-specific PSF size of the red image data RID based on the red pixel values (R) of the input image IMG_in. For example, the defocus calculation unit 211a may calculate the pixel values of the red image data RID based on the red pixel values (R) of the input image IMG_in (e.g., through an interpolation algorithm) and may then calculate the first variances.

As in the above description, the defocus calculation unit 211a may calculate second variances each indicating the pixel-specific PSF size of the green image data GID based on the green pixel values (G) of the input image IMG_in. The green image data GID may be generated by interpolating the green pixel values (G) of the input image IMG_in. That is, the green image data GID may correspond to the panchromatic image data PID of FIG. 3B. Also, the defocus calculation unit 211a may calculate third variances each indicating the pixel-specific PSF size of the blue image data BID based on the blue pixel values (B) of the input image IMG_in. The defocus calculation unit 211a may calculate fourth variances each indicating the pixel-specific PSF size of the panchromatic image data PID based on the pixel values of the panchromatic image data PID.

The defocus calculation unit 211a may calculate first variance ratios based on the first variances and the fourth variances. The defocus calculation unit 211a may calculate second variance ratios based on the second variances and the fourth variances. The defocus calculation unit 211a may calculate third variance ratios based on the third variances and the fourth variances.

The estimation PSF generation unit 213a may adjust the sizes of the reference PSFs based on the first variance ratios and may generate the first estimation PSF set EPST_R. The estimation PSF generation unit 213a may adjust the sizes of the reference PSFs based on the second variance ratios and may generate second estimation PSF set EPST_G. The estimation PSF generation unit 213a may adjust the sizes of the reference PSFs based on the third variance ratios and may generate third estimation PSF set EPST_B.

The interpolation image generation unit 221a may adjust the PSF sizes of the red image data RID, the green image data GID, the blue image data BID, and the panchromatic image data PID based on the PSF information PSF_info and the estimation PSF sets EPST and may generate the interpolation image IMG_C. According to the above description, the occurrence of the false color phenomenon due to the PSF differences of the red image data RID, the green image data GID, the blue image data BID, and the panchromatic image data PID may be alleviated.

FIG. 14 is a diagram illustrating an example of an interpolation image generator of FIG. 13 according to some implementations. In FIG. 14, the interpolation image generation unit 221a may include a pre-processor 221a_a, a color information image data generator 221a_b, and an interpolation image generator 221a_c. The pre-processor 221a_a, the color information image data generator 221a_b, and the interpolation image generator 221a_c may respectively correspond to the pre-processor 221_a, the color information image data generator 221_b, and the interpolation image generator 221_c of FIG. 11.

The pre-processor 221a_a may generate the pre-processing image data IDAT_P through the interpolation for the input image IMG_in. The pre-processing image data IDAT_P may include the red image data RID, green image data GID, the blue image data BID, and the panchromatic image data PID. The pre-processor 221a_a may transmit the pre-processing image data IDAT_P to the color information image data generator 221a_b. The pre-processor 221a_a may transmit the panchromatic image data PID to the color information image data generator 221a_b and the interpolation image generator 221a_c.

The color information image data generator 221a_b may adjust PSFs of at least some of the red image data RID, green image data GID, the blue image data BID, and the panchromatic image data PID, based on the PSF information PSF_info and the estimation PSF sets EPST. The color information image data generator 221a_b may generate the red image data RID, green image data GID, the blue image data BID, and the panchromatic image data PID by utilizing image data whose PSF is adjusted. The red information image data RIID may include information about the red color of the input image IMG_in. The green information image data GIID may include information about the green color of the input image IMG_in. The blue information image data BIID may include information about the blue color of the input image IMG_in.

The interpolation image generator 221a_c may generate the interpolation image IMG_C by combing the red information image data RIID, [symbol] green information image data GIID, the blue information image data BIID, and the panchromatic image data PID.

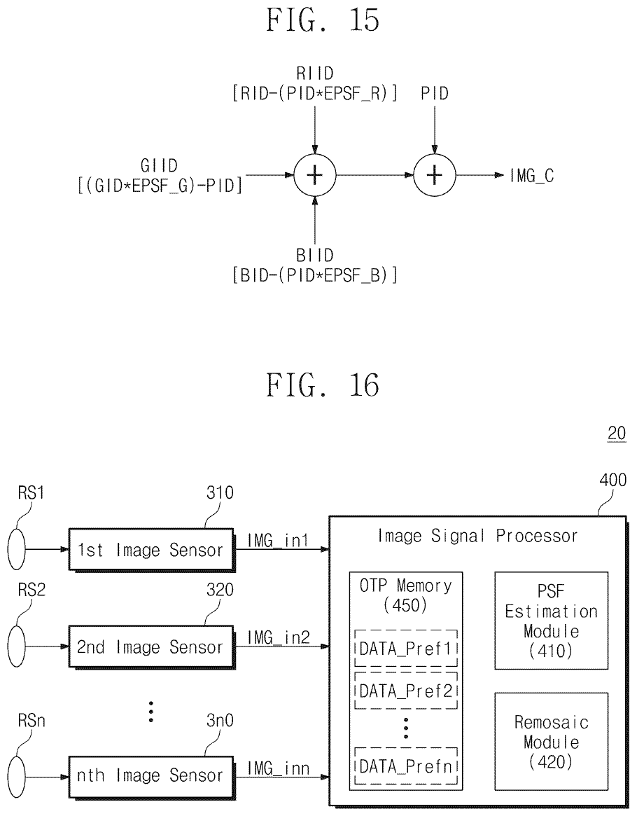

FIG. 15 is a diagram illustrating an example of operations of a color information image data generator and an interpolation image generator of FIG. 14 according to some implementations. In FIG. 15, it is assumed that the sizes of the PSFs corresponding to the red image data RID and the blue image data BID are larger than the sizes of the PSFs corresponding to the panchromatic image data PID and the sizes of the PSFs corresponding to the green image data GID are smaller than the sizes of the PSFs corresponding to the panchromatic image data PID.

In this case, the color information image data generator 221a_b may generate the red information image data RIID by subtracting a result of performing convolution between the panchromatic image data PID and the first estimation PSF set EPSF_R from the red image data RID. Through the convolution, the PSF size of the panchromatic image data PID may increase. Accordingly, the red information image data RIID may be data generated after decreasing the PSF difference of the red image data RID and the panchromatic image data PID.

The color information image data generator 221a_b may generate the green information image data GIID by subtracting a result of performing convolution between the green image data GID and a second estimation PSF set EPSF_G from the panchromatic image data PID. Through the convolution, the PSF size of the green image data GID may increase. Accordingly, the green information image data GIID may be data generated after decreasing the PSF difference of the green image data GID and the panchromatic image data PID.

The color information image data generator 221a_b may generate the blue information image data BIID by subtracting a result of performing convolution between the panchromatic image data PID and a third estimation PSF set EPSF_B from the blue image data BID. Through the convolution, the PSF size of the panchromatic image data PID may increase. Accordingly, the blue information image data BIID may be data generated after decreasing the PSF difference of the blue image data BID and the panchromatic image data PID.

The interpolation image generator 221a_c may generate the interpolation image IMG_C by combing the red information image data RIID, green information image data GIID, the blue information image data BIID, and the panchromatic image data PID. As described above, the red information image data RIID, the green information image data GIID, and the blue information image data BIID may be data generated by correcting the PSF differences of the image data RID, GID, and BID and the panchromatic image data PID. Accordingly, the interpolation image IMG_C may be an image in which the occurrence of the false color phenomenon due to the PSF difference is alleviated.

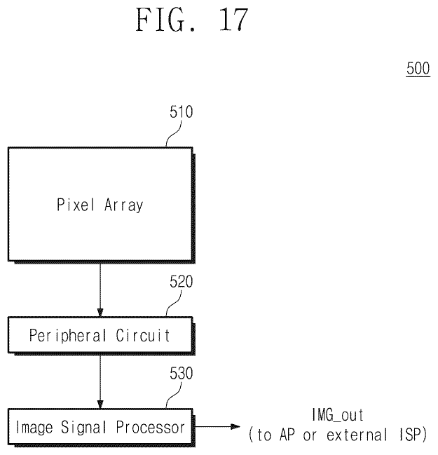

FIG. 16 is a block diagram illustrating an example of an image system according to some implementations. In FIG. 16, an image system 20 may include a plurality of lenses RS1 to RSn, a plurality of image sensors 310 to 3n0, and an image signal processor 400. The first image sensor 310 may correspond to the first lens RS1, the second image sensor 320 may correspond to the second lens RS2, and the n-th image sensor 3n0 may correspond to the n-th lens RSn. The plurality of image sensors 310 to 3n0 may transmit a plurality of input images IMG_in1 to IMG_inn generated by the light passing through the corresponding lens (e.g., RS1 to RSn) to the image signal processor 400.

The image signal processor 400 may perform signal processing for the plurality of input images IMG_in1 to IMG_inn. The image signal processor 400 may include a PSF estimation module 410, a remosaic module 420, and an OTP memory 450. The PSF estimation module 410 may estimate PSFs respectively corresponding to the plurality of input images IMG_in1 to IMG_inn.

The remosaic module 420 may perform interpolation for each of the plurality of input images IMG_in1 to IMG_inn, based on the estimated PSFs.

The OTP memory 450 may include reference PSF data DATA_Pref1 to DATA_Prefn respectively corresponding to the plurality of image sensors 310 to 3n0. The first reference PSF data DATA_Pref1 may correspond to the first image sensor 310, the second reference PSF data DATA_Pref2 may correspond to the second image sensor 320, and the n-th reference PSF data DATA_Prefn may correspond to the n-th image sensor 3n0.

The first reference PSF data DATA_Pref1 may refer to data in which information about first reference PSFs respectively corresponding to the pixels of the first input image IMG_in1 is compressed (or encoded). The second reference PSF data DATA_Pref2 may refer to data in which information about second reference PSFs respectively corresponding to the pixels of the second input image IMG_in2 is compressed (or encoded). The n-th reference PSF data DATA_Prefn may refer to data in which information about n-th reference PSFs respectively corresponding to the pixels of the n-th input image IMG_inn is compressed (or encoded).

For example, the first reference PSFs may be PSFs generated in advance through the measurement which is made based on the physical characteristic of the first lens RS1 during the process of manufacturing the image system 20. For example, the second reference PSFs may be PSFs generated in advance through the measurement which is made based on the physical characteristic of the second lens RS2 during the process of manufacturing the image system 20. For example, the n-th reference PSFs may be PSFs generated in advance through the measurement which is made based on the physical characteristic of the n-th lens RSn during the process of manufacturing the image system 20.

The PSF estimation module 410 may generate the first estimation PSFs corresponding to the first input image IMG_in1 by adjusting the sizes of the first reference PSFs depending on the method or configuration described with reference to FIGS. 1 to 15. The PSF estimation module 410 may generate the second estimation PSFs corresponding to the second input image IMG_in2 by adjusting the sizes of the second reference PSFs depending on the method or configuration described with reference to FIGS. 1 to 15. The PSF estimation module 410 may generate the n-th estimation PSFs corresponding to the n-th input image IMG_inn by adjusting the sizes of the n-th reference PSFs depending on the method or configuration described with reference to FIGS. 1 to 15.

In this case, the remosaic module 420 may perform interpolation for the first input image IMG_in1 based on the first estimation PSFs, may perform interpolation for the second input image IMG_in2 based on the second estimation PSFs, and may perform interpolation for the n-th input image IMG_inn based on the n-th estimation PSFs.

That is, according to some implementations, the image signal processor 400 may estimate an PSF corresponding to each of the plurality of input images IMG_in1 to IMG_inn based on the reference PSFs corresponding to the plurality of image sensors 310 to 3n0. The image signal processor 400 may perform interpolation for the input images IMG_in1 to IMG_inn based on the estimated PSFs.

FIG. 17 is a block diagram illustrating an example of an image sensor according to some implementations. In FIG. 17, an image sensor 500 may include a pixel array 510, a peripheral circuit 520, and an image signal processor 530.

The pixel array 510 may include a plurality of pixels. The peripheral circuit 520 may be configured to process information obtained from the plurality of pixels of the pixel array 510. In an embodiment, the peripheral circuit 520 may include various components, which are necessary to generate image data in the image sensor 500, such as a row driver, an ADC, a memory, and a ramp signal generator.

The image signal processor 530 may perform image signal processing for an input image obtained by the peripheral circuit 520 and may output the output image IMG_out. That is, an image signal processor is implemented independently of an image sensor are described above, but the present disclosure is not limited thereto. For example, as illustrated in FIG. 17, the whole image signal processor 530 or at least a part of the image signal processor 530 may be included in the image sensor 500.

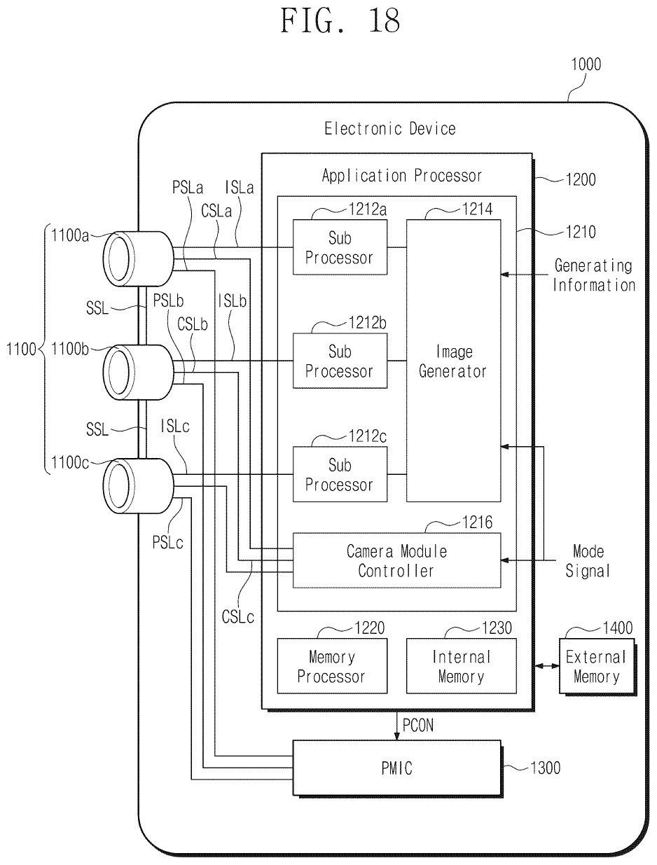

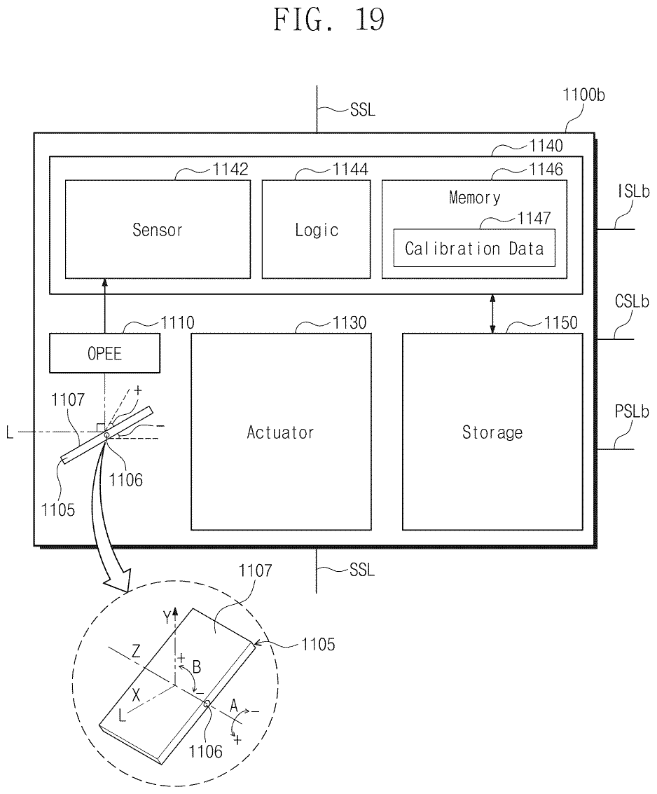

FIG. 18 is a block diagram illustrating an example of an electronic device including a multi-camera module according to some implementations. FIG. 19 is a block diagram illustrating an example of a camera module of FIG. 18 in detail according to some implementations.

In FIG. 18, an electronic device 1000 may include a camera module group 1100, an application processor 1200, a PMIC 1300, and an external memory 1400. The camera module group 1100 may include a plurality of camera modules 1100a, 1100b, and 1100c. An electronic device including three camera modules 1100a, 1100b, and 1100c is illustrated in FIG. 18, but the present disclosure is not limited thereto. In some implementations, the camera module group 1100 may be modified to include only two camera modules. Also, in some implementations, the camera module group 1100 may be modified to include “n” camera modules (n being a natural number of 4 or more).

Below, a detailed configuration of the camera module 1100b will be more fully described with reference to FIG. 19, but the following description may be equally applied to the remaining camera modules 1100a and 1100c.

In FIG. 19, the camera module 1100b may include a prism 1105, an optical path folding element (OPFE) 1110, an actuator 1130, an image sensing device 1140, and storage 1150. The prism 1105 may include a reflecting plane 1107 of a light reflecting material and may change a path of a light “L” incident from the outside.

In some implementations, the prism 1105 may change a path of the light “L” incident in a first direction (X) to a second direction (Y) perpendicular to the first direction (X), Also, the prism 1105 may change the path of the light “L” incident in the first direction (X) to the second direction (Y) perpendicular to the first (X-axis) direction by rotating the reflecting plane 1107 of the light reflecting material in direction “A” about a central axis 1106 or rotating the central axis 1106 in direction “B”. In this case, the OPFE 1110 may move in a third direction (Z) perpendicular to the first direction (X) and the second direction (Y).

In some implementations, as illustrated in FIG. 19, a maximum rotation angle of the prism 1105 in direction “A” may be equal to or smaller than 15 degrees in a positive A direction and may be greater than 15 degrees in a negative A direction, but the present disclosure is not limited thereto.

In some implementations, the prism 1105 may move within approximately 20 degrees in a positive or negative B direction, between 10 degrees and 20 degrees, or between 15 degrees and 20 degrees; here, the prism 1105 may move at the same angle in the positive or negative B direction or may move at a similar angle within approximately 1 degree.

In some implementations, the prism 1105 may move the reflecting plane 1107 of the light reflecting material in the third direction (e.g., Z direction) parallel to a direction in which the central axis 1106 extends.

The OPFE 1110 may include optical lenses composed of “m” groups (m being a natural number), for example. Here, “m” lens may move in the second direction (Y) to change an optical zoom ratio of the camera module 1100b. For example, when a default optical zoom ratio of the camera module 1100b is “Z”, the optical zoom ratio of the camera module 1100b may be changed to an optical zoom ratio of 3Z, 5Z, or 5Z or more by moving “m” optical lens included in the OPFE 1110.

The actuator 1130 may move the OPFE 1110 or an optical lens (hereinafter referred to as an “optical lens”) to a specific location. For example, the actuator 1130 may adjust a location of an optical lens such that an image sensor 1142 is placed at a focal length of the optical lens for accurate sensing.

The image sensing device 1140 may include the image sensor 1142, control logic 1144, and a memory 1146. The image sensor 1142 may sense an image of a sensing target by using the light “L” provided through an optical lens. The control logic 1144 may control overall operations of the camera module 1100b. For example, the control logic 1144 may control an operation of the camera module 1100b based on a control signal provided through a control signal line CSLb.

The memory 1146 may store information, which is necessary for an operation of the camera module 1100b, such as calibration data 1147. The calibration data 1147 may include information necessary for the camera module 1100b to generate image data by using the light “L” provided from the outside. The calibration data 1147 may include, for example, information about the degree of rotation described above, information about a focal length, information about an optical axis, etc. In the case where the camera module 1100b is implemented in the form of a multi-state camera in which a focal length varies depending on a location of an optical lens, the calibration data 1147 may include a focal length value for each location (or state) of the optical lens and information about auto focusing.

The storage 1150 may store image data sensed through the image sensor 1142. The storage 1150 may be disposed outside the image sensing device 1140 and may be implemented in a shape where the storage 1150 and a sensor chip constituting the image sensing device 1140 are stacked. In some embodiments, the storage 1150 may be implemented with an electrically erasable programmable read only memory (EEPROM), but the present disclosure is not limited thereto.

In FIGS. 18 and 19, in some implementations, each of the plurality of camera modules 1100a, 1100b, and 1100c may include the actuator 1130. As such, the same calibration data 1147 or different calibration data 1147 may be included in the plurality of camera modules 1100a, 1100b, and 1100c depending on operations of the actuators 1130 therein.

In some implementations, one camera module (e.g., 1100b) among the plurality of camera modules 1100a, 1100b, and 1100c may be a folded lens shape of camera module in which the prism 1105 and the OPFE 1110 described above are included, and the remaining camera modules (e.g., 1100a and 1100c) may be a vertical shape of camera module in which the prism 1105 and the OPFE 1110 described above are not included; however, the present disclosure is not limited thereto.

In some implementations, one camera module (e.g., 1100c) among the plurality of camera modules 1100a, 1100b, and 1100c may be, for example, a vertical shape of depth camera extracting depth information by using an infrared ray (IR). In this case, the application processor 1200 may merge image data provided from the depth camera and image data provided from any other camera module (e.g., 1100a or 1100b) and may generate a three-dimensional (3D) depth image. In some implementations, at least two camera modules (e.g., 1100a and 1100b) among the plurality of camera modules 1100a, 1100b, and 1100c may have different fields of view. In this case, the at least two camera modules (e.g., 1100a and 1100b) among the plurality of camera modules 1100a, 1100b, and 1100c may include different optical lens, but the present disclosure is not limited thereto.

Also, in some implementations, fields of view of the plurality of camera modules 1100a, 1100b, and 1100c may be different. In this case, the plurality of camera modules 1100a, 1100b, and 1100c may include different optical lens, not limited thereto.

In some implementations, the plurality of camera modules 1100a, 1100b, and 1100c may be disposed to be physically separated from each other. That is, the plurality of camera modules 1100a, 1100b, and 1100c may not use a sensing area of one image sensor 1142, but the plurality of camera modules 1100a, 1100b, and 1100c may include independent image sensors 1142 therein, respectively.

In FIG. 18, the application processor 1200 may include an image processing device 1210, a memory controller 1220, and an internal memory 1230. The application processor 1200 may be implemented to be separated from the plurality of camera modules 1100a, 1100b, and 1100c. For example, the application processor 1200 and the plurality of camera modules 1100a, 1100b, and 1100c may be implemented with separate semiconductor chips.

The image processing device 1210 may include a plurality of sub image processors 1212a, 1212b, and 1212c, an image generator 1214, and a camera module controller 1216. The image processing device 1210 may include the plurality of sub image processors 1212a, 1212b, and 1212c, the number of which corresponds to the number of the plurality of camera modules 1100a, 1100b, and 1100c.

Image data respectively generated from the camera modules 1100a, 1100b, and 1100c may be respectively provided to the corresponding sub image processors 1212a, 1212b, and 1212c through separated image signal lines ISLa, ISLb, and ISLc. For example, the image data generated from the camera module 1100a may be provided to the sub image processor 1212a through the image signal line ISLa, the image data generated from the camera module 1100b may be provided to the sub image processor 1212b through the image signal line ISLb, and the image data generated from the camera module 1100c may be provided to the sub image processor 1212c through the image signal line ISLc. This image data transmission may be performed, for example, by using a camera serial interface (CSI) based on the MIPI (Mobile Industry Processor Interface), but the present disclosure is not limited thereto.

Meanwhile, in some implementations, one sub image processor may be disposed to correspond to a plurality of camera modules. For example, the sub image processor 1212a and the sub image processor 1212c may be integrally implemented, not separated from each other as illustrated in FIG. 16; in this case, one of the pieces of image data respectively provided from the camera module 1100a and the camera module 1100c may be selected through a selection element (e.g., a multiplexer), and the selected image data may be provided to the integrated sub image processor.

The image data respectively provided to the sub image processors 1212a, 1212b, and 1212c may be provided to the image generator 1214. The image generator 1214 may generate an output image by using the image data respectively provided from the sub image processors 1212a, 1212b, and 1212c, depending on image generating information Generating Information or a mode signal.

In detail, the image generator 1214 may generate the output image by merging at least a portion of the image data respectively generated from the camera modules 1100a, 1100b, and 1100c having different fields of view, depending on the image generating information Generating Information or the mode signal. Also, the image generator 1214 may generate the output image by selecting one of the image data respectively generated from the camera modules 1100a, 1100b, and 1100c having different fields of view, depending on the image generating information Generating Information or the mode signal.

In some implementations, the image generating information Generating Information may include a zoom signal or a zoom factor. Also, in some implementations, the mode signal may be, for example, a signal based on a mode selected from a user.

In the case where the image generating information Generating Information is the zoom signal (or zoom factor) and the camera modules 1100a, 1100b, and 1100c have different visual fields of view, the image generator 1214 may perform different operations depending on a kind of the zoom signal. For example, in the case where the zoom signal is a first signal, the image generator 1214 may merge the image data output from the camera module 1100a and the image data output from the camera module 1100c and may generate the output image by using the merged image signal and the image data output from the camera module 1100b that is not used in the merging operation. In the case where the zoom signal is a second signal different from the first signal, without the image data merging operation, the image generator 1214 may select one of the image data respectively output from the camera modules 1100a, 1100b, and 1100c and may output the selected image data as the output image. However, the present disclosure is not limited thereto, and a way to process image data may be modified without limitation if necessary.

In some implementations, the image generator 1214 may generate merged image data having an increased dynamic range by receiving a plurality of image data of different exposure times from at least one of the plurality of sub image processors 1212a, 1212b, and 1212c and performing high dynamic range (HDR) processing on the plurality of image data.

The camera module controller 1216 may provide control signals to the camera modules 1100a, 1100b, and 1100c, respectively. The control signals generated from the camera module controller 1216 may be respectively provided to the corresponding camera modules 1100a, 1100b, and 1100c through control signal lines CSLa, CSLb, and CSLc separated from each other.

One of the plurality of camera modules 1100a, 1100b, and 1100c may be designated as a master camera (e.g., 1100b) depending on the image generating information Generating Information including a zoom signal or the mode signal, and the remaining camera modules (e.g., 1100a and 1100c) may be designated as a slave camera. The above designation information may be included in the control signals, and the control signals including the designation information may be respectively provided to the corresponding camera modules 1100a, 1100b, and 1100c through the control signal lines CSLa, CSLb, and CSLc separated from each other.

Camera modules operating as a master and a slave may be changed depending on the zoom factor or an operating mode signal. For example, in the case where the field of view of the camera module 1100a is wider than the field of view of the camera module 1100b and the zoom factor indicates a low zoom ratio, the camera module 1100b may operate as a master, and the camera module 1100a may operate as a slave. In contrast, in the case where the zoom factor indicates a high zoom ratio, the camera module 1100a may operate as a master, and the camera module 1100b may operate as a slave.

In some implementations, the control signal provided from the camera module controller 1216 to each of the camera modules 1100a, 1100b, and 1100c may include a sync enable signal. For example, in the case where the camera module 1100b is used as a master camera and the camera modules 1100a and 1100c are used as a slave camera, the camera module controller 1216 may transmit the sync enable signal to the camera module 1100b. The camera module 1100b that is provided with sync enable signal may generate a sync signal based on the provided sync enable signal and may provide the generated sync signal to the camera modules 1100a and 1100c through a sync signal line SSL. The camera module 1100b and the camera modules 1100a and 1100c may be synchronized with the sync signal to transmit image data to the application processor 1200.

In some implementations, the control signal provided from the camera module controller 1216 to each of the camera modules 1100a, 1100b, and 1100c may include mode information according to the mode signal. Based on the mode information, the plurality of camera modules 1100a, 1100b, and 1100c may operate in a first operating mode and a second operating mode with regard to a sensing speed.

In the first operating mode, the plurality of camera modules 1100a, 1100b, and 1100c may generate image signals at a first speed (e.g., may generate image signals of a first frame rate), may encode the image signals at a second speed (e.g., may encode the image signal of a second frame rate higher than the first frame rate), and transmit the encoded image signals to the application processor 1200. In this case, the second speed may be 30 times or less the first speed.

The application processor 1200 may store the received image signals, that is, the encoded image signals in the memory 1230 provided therein or the storage 1400 placed outside the application processor 1200. Afterwards, the application processor 1200 may read and decode the encoded image signals from the memory 1230 or the storage 1400 and may display image data generated based on the decoded image signals. For example, the corresponding one among sub image processors 1212a, 1212b, and 1212c of the image processing device 1210 may perform decoding and may also perform image processing on the decoded image signal.

In the second operating mode, the plurality of camera modules 1100a, 1100b, and 1100c may generate image signals at a third speed (e.g., may generate image signals of a third frame rate lower than the first frame rate) and transmit the image signals to the application processor 1200. The image signals provided to the application processor 1200 may be signals that are not encoded. The application processor 1200 may perform image processing on the received image signals or may store the image signals in the memory 1230 or the storage 1400.

The PMIC 1300 may supply powers, for example, power supply voltages to the plurality of camera modules 1100a, 1100b, and 1100c, respectively. For example, under control of the application processor 1200, the PMIC 1300 may supply a first power to the camera module 1100a through a power signal line PSLa, may supply a second power to the camera module 1100b through a power signal line PSLb, and may supply a third power to the camera module 1100c through a power signal line PSLc.

In response to a power control signal PCON from the application processor 1200, the PMIC 1300 may generate a power corresponding to each of the plurality of camera modules 1100a, 1100b, and 1100c and may adjust a level of the power. The power control signal PCON may include a power adjustment signal for each operating mode of the plurality of camera modules 1100a, 1100b, and 1100c. For example, the operating mode may include a low-power mode. In this case, the power control signal PCON may include information about a camera module operating in the low-power mode and a set power level. Levels of the powers respectively provided to the plurality of camera modules 1100a, 1100b, and 1100c may be identical to each other or may be different from each other. Also, a level of a power may be dynamically changed.

According to the present disclosure, an image signal processor may estimate point spread functions (PSFs) corresponding to an input image. The image signal processor may perform interpolation for the input image based on the estimated PSFs. In this case, the occurrence of a false color phenomenon in an output image may be alleviated. Accordingly, an image signal processor with improved performance, an image system including the image signal processor, and an operation method of the image signal processor may be provided.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been described with reference to different implementations, it will be apparent to those of ordinary skill in the art that various changes and modifications may be made thereto without departing from the spirit and scope of the present disclosure as set forth in the following claims.

What is claimed is:

1. An image signal processor configured to receive an input image from an image sensor, the image signal processor comprising:
a point spread function (PSF) estimation circuit configured to
adjust, based on pre-processing image data, sizes of a plurality of reference PSFs corresponding to the image sensor, wherein the pre-processing image data is based on the input image, and
generate a plurality of estimation PSFs indicating an estimation result for a plurality of PSFs corresponding to the input image; and
a remosaic circuit configured to
generate the pre-processing image data based on the input image, and
perform interpolation of the input image based on the plurality of estimation PSFs.

2. The image signal processor of claim 1, wherein the pre-processing image data comprises first image data comprising brightness information of the input image.

3. The image signal processor of claim 2,
wherein the PSF estimation circuit comprises a defocus calculation circuit,
wherein the defocus calculation circuit is configured to:
calculate, based on first pixel values from the input image, a first variance of a first pixel among a plurality of pixels of the input image;
calculate, based on second pixel values from the first image data, a second variance of the first pixel; and
calculate, based on the first variance and the second variance, a first variance ratio corresponding to the first pixel.

4. The image signal processor of claim 3, wherein the defocus calculation circuit is further configured to:
perform brightness normalization of the first pixel values based on the first image data to produce brightness-normalized first pixel values; and
calculate the first variance based on the brightness-normalized first pixel values.

5. The image signal processor of claim 3, wherein the plurality of estimation PSFs comprise:
a plurality of first estimation PSFs associated with a first color channel of the input image and respectively corresponding to the plurality of pixels of the input image; and
a plurality of second estimation PSFs associated with a second color channel of the input image and respectively corresponding to the plurality of pixels of the input image.

6. The image signal processor of claim 3, wherein the PSF estimation circuit comprises an estimation PSF generation circuit configured to generate, based on the first variance ratio, a first estimation PSF corresponding to the first pixel by adjusting a size of a first reference PSF of the plurality of reference PSFs, wherein the first reference PSF corresponds to the first pixel.

7. The image signal processor of claim 1, wherein the image signal processor comprises a memory configured to store reference PSF data associated with the plurality of reference PSFs.

8. The image signal processor of claim 7, wherein the memory comprises a one-time programmable (OTP) memory.

9. The image signal processor of claim 7,
wherein the PSF estimation circuit comprises a reference PSF extraction circuit,
wherein the reference PSF extraction circuit is configured to obtain the plurality of reference PSFs respectively corresponding to a plurality of pixels of the input image, based on the reference PSF data and position information indicating a position of each of the plurality of pixels of the input image.

10. The image signal processor of claim 2, wherein the first image data are based on green pixel values of the input image.

11. The image signal processor of claim 1, wherein the PSF estimate circuit is configured to generate the plurality of PSFs corresponding to the input image based on two or more of a defocus degree of a lens corresponding to the image sensor, a material of the lens, and a tilt degree of the lens.

12. The image signal processor of claim 1, wherein the remosaic circuit comprises:
an interpolation image generation circuit configured to generate an interpolation image based on the plurality of estimation PSFs; and
a remosaic image generation circuit configured to generate a remosaic image based on the interpolation image.

13. The image signal processor of claim 12, wherein the interpolation image generation circuit is configured to use the plurality of estimation PSFs to alleviate a false color phenomenon.

14. An operation method of an image signal processor, the method comprising:
receiving an input image from an image sensor;
generating, based on the input image, pre-processing image data;
generating, based on the pre-processing image data, a plurality of estimation point spread functions (PSFs) by adjusting sizes of a plurality of reference PSFs corresponding to the image sensor; and
generating, based on the plurality of estimation PSFs, an interpolation image by performing interpolation of the input image,
wherein the plurality of estimation PSFs indicate an estimation result for a plurality of PSFs respectively corresponding to pixels of the input image.

15. The method of claim 14, wherein generating the pre-processing image data comprises:
generating first image data based on first pixel values of the input image;
generating second image data based on second pixel values of the input image; and
generating third image data based on third pixel values of the input image.

16. The method of claim 15, wherein generating the plurality of estimation PSFs comprises:
performing brightness normalization of the first image data based on the second image data;
calculating a first variance corresponding to a first pixel of the first image data;
calculating a second variance corresponding to a first pixel of the second image data;
calculating a first variance ratio based on the first variance and the second variance; and
generating, based on the first variance ratio, a first estimation PSF by adjusting a size of a first reference PSF, of the plurality of reference PSFs, corresponding to the first pixel of the input image.

17. The method of claim 16, wherein generating the interpolation image comprises, when the first variance is smaller than the second variance, increasing a size of a first PSF, of the plurality of PSFs, corresponding to the first pixel of the second image data based on the first estimation PSF.

18. The method of claim 15, wherein the first pixel values comprise red pixel values, the second pixel values comprise green pixel values, and the third pixel values comprise blue pixel values.

19. An image system comprising:
a first image sensor configured to output a first input image;
a second image sensor configured to output a second input image; and
an image signal processor,
wherein the image signal processor includes:
a memory device configured to store first reference point spread function (PSF) data associated with first reference PSFs corresponding to the first image sensor and second reference PSF data associated with second reference PSFs corresponding to the second image sensor;
a PSF estimation circuit configured to
adjust sizes of the first reference PSFs to generate a plurality of first estimation PSFs indicating an estimation result for PSFs corresponding to the first input image, and
adjust sizes of the second reference PSFs to generate a plurality of second estimation PSFs indicating an estimation result for PSFs corresponding to the second input image; and
a remosaic circuit configured to
perform interpolation of the first input image based on the plurality of first estimation PSFs, and
perform interpolation of the second input image based on the plurality of second estimation PSFs.

20. The image system of claim 19, wherein the PSF estimation circuit is configured to:
obtain, based on the first reference PSF data, the first reference PSFs respectively corresponding to a plurality of pixels of the first input image; and
obtain, based on the second reference PSF data, the second reference PSFs respectively corresponding to a plurality of pixels of the second input image.
